(19) United States
(12) Patent Application Publication
(10) Pub. No.: US 2012/0176372 A1
(43) Pub. Date: Jul. 12, 2012

(54) DISPLAY APPARATUS AND DISPLAY SYSTEM HAVING THE SAME

(75) Inventors: Bo-Ram KIM, Asan-si (KR); Byoung-Jun LEE, Cheonan-si (KR); So-Young KIM, Suwon-si (KR); Seung-Hwan MOON, Asan-si (KR)

(73) Assignee: SAMSUNG ELECTRONICS CO., LTD., Suwon-si (KR)

(21) Appl. No.: 13/186,655

(22) Filed: Jul. 20, 2011

(30) Foreign Application Priority Data
Jan. 6, 2011 (KR) 2011-0001289

(51) Int. Cl. G06T 15/00

(52) U.S. Cl. 345/419

(57) ABSTRACT

A display apparatus includes a touch display panel which displays a three-dimensional stereoscopic image and senses a touch position, and a light-receiving part disposed on the touch display panel and which receives a remote control signal generated from shutter glasses used to view the three-dimensional stereoscopic image from the touch display panel.

This application claims priority to Korean Patent Application No. 2011-0001289, filed on Jan. 6, 2011, and all the benefits accruing therefrom under 35 U.S.C. §119, the content of which in its entirety is herein incorporated by reference.

### BACKGROUND OF THE INVENTION

(1) Field of the Invention

Exemplary embodiments of the present invention relate to a display apparatus and a display system having the display apparatus. More particularly, exemplary embodiments of the present invention relate to a display apparatus which displays a three-dimensional (“3D”) stereoscopic image and a display system having the display apparatus.

(2) Description of the Related Art

Generally, a liquid crystal display (“LCD”) apparatus displays a two-dimensional (“2D”) image. Recently, demand for a 3D stereoscopic image has been increased in various fields, such as games and movies, for example, such that the LCD apparatus for displaying the 3D stereoscopic image has been developed.

The 3D stereoscopic image is displayed using a binocular parallax principle through both eyes. For example, since two eyes of human are spaced apart from each other, the images viewed at the different angles by the two eyes are inputted to the brain of human. Thus, the observer may recognize the 3D stereoscopic image from the images displayed on the display apparatus.

A method of displaying the 3D stereoscopic image is generally classified into a shutter-glasses type and an auto-stereoscopic type. The shutter-glasses type includes a passive polarization shutter type and an active liquid crystal (“LC”) shutter type. In the passive polarization shutter type, a view wears glasses including polarization filters having different polarization axes corresponding to two eyes of the viewer, respectively. In the active LC shutter type, the images are timely-divided into a left eye image and a right eye image, and the viewer wears glasses which sequentially open or close a left eye LC shutter glass and a right eye LC shutter glass synchronized with the display timing of the left and right eye images.

In the active LC shutter type, the LC shutter glass unit (“GU”) may receive a left eye LC shutter open/close signal and a right eye LC shutter open/close signal synchronized with the left eye image and the right eye image from an infrared (“IR”) emitter connected to an external device to open/close the left eye LC shutter and the right eye LC shutter.

However, in the active LC shutter type, since the left eye LC shutter open/close signal and the right shutter LC open/close signal are generated from the external device, a user may prepare and set up an IR emitter connected to the external device to provide the left eye LC shutter open/close signal and the right eye LC shutter open/close signal to the LC shutter glasses.

### BRIEF SUMMARY OF THE INVENTION

Exemplary embodiments of the present invention provide a display apparatus convenient to a user.

Exemplary embodiments of the present invention also provide a display system having the display apparatus.

In an exemplary embodiment, a display apparatus includes a touch display panel which displays a three-dimensional stereoscopic image and senses a touch position, and a light-receiving part disposed on the touch display panel, where the light-receiving part receives a remote control signal generated from shutter glasses used to view the three-dimensional stereoscopic image from the touch display panel.

In an exemplary embodiment, a display apparatus includes a display panel including a display area, in which a three-dimensional stereoscopic image is displayed, and a peripheral area around the display area, and a light-receiving part disposed in the peripheral area of the display panel, where a plurality of pixels is disposed in the display area of the display panel, and the light-receiving part receives a remote control signal generated from shutter glasses used to view the three-dimensional stereoscopic image from the display panel.

In an exemplary embodiment, a display system includes a display panel, a liquid crystal shutter glass unit and a first light-receiving part. The touch display panel displays a three-dimensional stereoscopic image and senses a touch position. The liquid crystal shutter glass unit including a left eye liquid crystal shutter, a right eye liquid crystal shutter and a first light-emitting part which transmits a remote control signal. The first light-receiving part is disposed on the touch display panel and receives the remote control signal.

In an exemplary embodiment, a display system includes a display panel, a liquid crystal shutter glass unit and a first light-receiving part. The display panel includes a display area, in which a three-dimensional stereoscopic image is displayed, and a peripheral area around the display area, where a plurality of pixels is disposed in the display area. The liquid crystal shutter glass unit includes a left eye liquid crystal shutter, a right eye liquid crystal shutter and a first light-emitting part which transmits a remote control signal. The first light-receiving is disposed in the peripheral area and receives the remote control signal.

According to exemplary embodiments, at least one of sensing elements disposed in a display area of a touch display panel functions as a first light-receiving part that receives a remote control signal transmitted from a shutter glasses part, such that a structure of a display system is substantially simplified and manufacturing cost of the display system is substantially reduced.

According to exemplary embodiments, a first light-emitting part, which transmits a left eye image synchronized signal and a right eye image synchronized signal that open or close a left eye LC shutter and a right eye LC shutter of an LC shutter glass unit, is disposed in a peripheral area of the touch display panel, such that a user may use the display system without self-installation process for the first light-emitting part.

According to exemplary embodiments, a first light-receiving that receives a remote control signal transmitted from a LC shutter glass unit is disposed in a peripheral area of the display panel, such that a user may use the display system without self-installation process for the first light-receiving part.

### BRIEF DESCRIPTION OF THE DRAWINGS

The above and other features and advantages of the invention will become more apparent by describing in detailed exemplary embodiments thereof with reference to the accompanying drawings, in which:

FIG. 1 is a block diagram illustrating an exemplary embodiment of a display system according to the present invention;

FIG. 2 is a block diagram illustrating an exemplary embodiment of a shutter glass unit of FIG. 1;

FIG. 3 is an exploded perspective view of an exemplary embodiment of a display apparatus of FIG. 1;

FIG. 4 is a partial block diagram illustrating an exemplary embodiment of a touch display panel of FIG. 3;

FIG. 5 is a partial cross-sectional view of an exemplary embodiment of the touch display panel of FIG. 3;

FIG. 6 is an exploded perspective view of an alternative exemplary embodiment of the display system according to the present invention;

FIG. 7 is a partial cross-sectional view of an exemplary embodiment of a touch display panel of FIG. 6;

FIG. 8 is a top plan view of an alternative exemplary embodiment of the display system according to the present invention; and

FIG. 9 is a top plan view of another alternative exemplary embodiment of the display system according to the present invention.

### DETAILED DESCRIPTION OF THE INVENTION

The invention is described more fully hereinafter with reference to the accompanying drawings, in which exemplary embodiments of the invention are shown. This invention may, however, be embodied in many different forms and should not be construed as limited to the exemplary embodiments set forth herein. Rather, these embodiments are provided so that this disclosure will be thorough and complete, and will fully convey the scope of the invention to those skilled in the art. In the drawings, the size and relative sizes of layers and regions may be exaggerated for clarity.

It will be understood that when an element or layer is referred to as being “on” or “connected to” another element or layer, the element or layer can be directly on or connected to another element or layer or intervening elements or layers. In contrast, when an element is referred to as being “directly on” or “directly connected to” another element or layer, there are no intervening elements or layers present. Like numbers refer to like elements throughout. As used herein, the term “and/or” includes any and all combinations of one or more of the associated listed items.

It will be understood that, although the terms first, second, third, etc., may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present invention.

Spatially relative terms, such as “lower”, “under,” “upper” and the like, may be used herein for ease of description to describe the relationship of one element or feature to another element(s) or feature(s) as illustrated in the figures. It will be understood that the spatially relative terms are intended to encompass different orientations of the device in use or operation, in addition to the orientation depicted in the figures. For example, if the device in the figures is turned over, elements described as “lower” or “under” relative to other elements or features would then be oriented “above” relative to the other elements or features. Thus, the exemplary term “lower” and “under” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof

Embodiments of the invention are described herein with reference to cross-section illustrations that are schematic illustrations of idealized embodiments (and intermediate structures) of the invention. As such, variations from the shapes of the illustrations as a result, for example, of manufacturing techniques and/or tolerances, are to be expected. Thus, embodiments of the invention should not be construed as limited to the particular shapes of regions illustrated herein but are to include deviations in shapes that result, for example, from manufacturing.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

All methods described herein can be performed in a suitable order unless otherwise indicated herein or otherwise clearly contradicted by context. The use of any and all examples, or exemplary language (e.g., “such as”), is intended merely to better illustrate the invention and does not pose a limitation on the scope of the invention unless otherwise claimed. No language in the specification should be construed as indicating any non-claimed element as essential to the practice of the invention as used herein.

Hereinafter, the invention will be explained in detail with reference to the accompanying drawings.

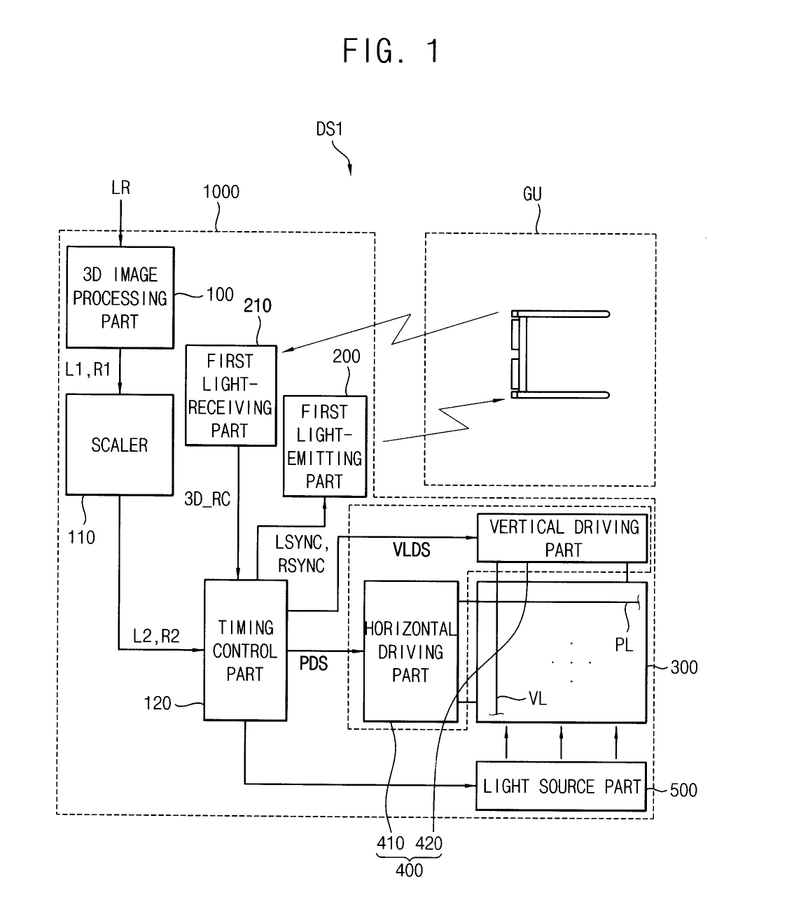

FIG. 1 is a block diagram illustrating an exemplary embodiment of a display system according to the present invention;

Referring to FIG. 1, a display system DS1 includes a display apparatus 1000 and a liquid crystal (“LC”) shutter glass unit GU. The display apparatus 1000 includes a three-dimensional (“3D”) image processing part 100, a scaler 110, a timing control part 120, a first light-emitting part 200, a first light-receiving part 210, a touch display panel 300, a panel driving part 400 and a light source part 500.

The 3D stereoscopic image processing part 100 receives a 3D compressed image LR from an external device to divide the 3D compressed image LR into a first left eye image L1 and a first right eye image R1. In an exemplary embodiment, the 3D compressed image LR is displayed with a driving frequency of 60 hertz (Hz), and each of the first left eye image L1 and the first right eye image R1 is displayed with a driving frequency of 120 Hz.

The scaler 110 receives the first left eye image L1 and the first right eye image R1 from the 3D stereoscopic image processing part 100 to convert the first left eye image L1 and the first right eye image R1 to a second left eye image L2 and a second right eye image R2, respectively. In one exemplary embodiment, for example, the scaler 110 controls a resolution of each of the first left eye image L1 and the first right eye image R1 based on a resolution of the touch display panel 300 to generate the second left eye image L2 and the second right eye image R2. In such an embodiment, each of the second left eye image L2 and the second right eye image R2 has a resolution substantially identical to the resolution of the touch display panel 300. In one exemplary embodiment, for example, when the touch display panel 300 has a resolution of 1920×1080, the scaler 110 converts the resolution of each of the second left eye image L2 and the second right eye image R2 to the resolution of 1920×1080.

In an exemplary embodiment, the scaler 110 increases an interval of a vertical blank between the second left eye image L2 and the second right eye image R2. The interval decreases the interference of a signal corresponding to the second right eye image R2 when a left shutter LS is open and the interference of a signal corresponding to the second left eye image L2 when a right shutter RS is open, such that crosstalk between the second left eye image L2 and the second right eye image R2 is effectively prevented.

The timing control part 120 receives the second left eye image L2 and the second right eye image R2 from the scaler 110. The timing control part 120 generates a left eye image synchronized signal LSYNC based on the second left eye image L2 and generates a right eye image synchronized signal RSYNC based on the second right eye image R2. The left eye image synchronized signal LSYNC includes information on opening or closing time of the left eye LC shutter LS, and the right eye image synchronized signal RSYNC includes information on opening or closing time of the right eye LC shutter RS.

In an exemplary embodiment, the timing control part 120 provides a horizontal driving signal PDS and a vertical driving signal VLDS to the panel driving part 400 to control the horizontal driving part 410 and the vertical driving part 420. The timing control part 120 may also provide a grayscale signal to the horizontal driving part 420.

In an exemplary embodiment, the timing control part 120 receives a remote control signal 3D_RC including a 3D stereoscopic image on/off signal, a 3D distance control signal and an infrared light (“IR”) output intensity control signal, for example, through the first light-receiving part 210 from the LC shutter glass unit GU.

The first light-emitting part 200 receives the left eye image synchronized signal LSYNC and the right eye image synchronized signal RSYNC from the timing control part 120 to provide the left eye image synchronized signal LSYNC and the right eye image synchronized signal RSYNC to the LC shutter glass unit GU. The first light-receiving part 210 remotely receives the remote control signal 3D_RC from the LC shutter glass unit GU to provide the remote control signal 3D_RC to the timing control part 120.

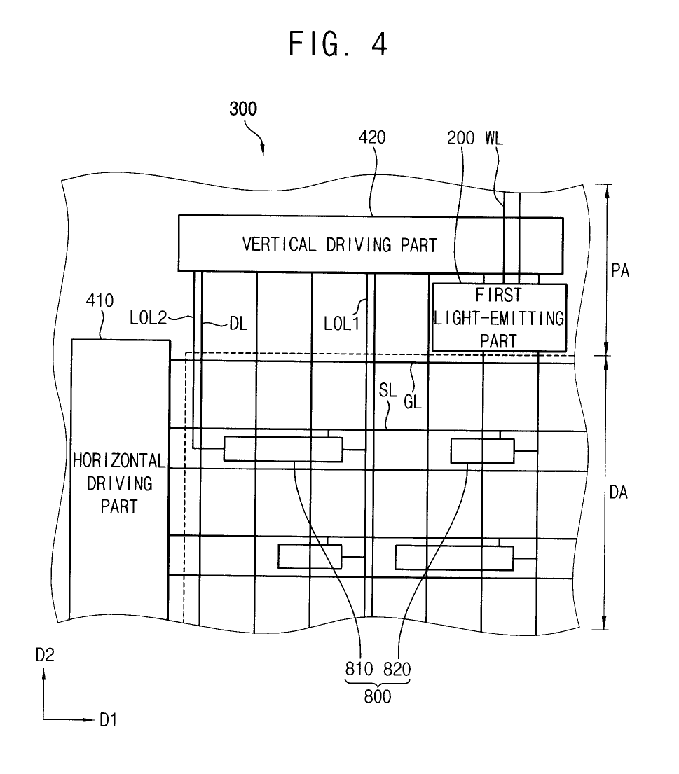

The touch display panel 300 includes a plurality of horizontal lines PL and a plurality of vertical lines VL. The horizontal lines PL includes a plurality of gate lines and a plurality of sensing lines, and the vertical lines VL includes a plurality of data lines, a plurality of first read-out lines and at least one second read-out line. The horizontal lines PL and the vertical lines VL will be described later in detail referring to FIG. 4.

The panel driving part 400 includes a horizontal driving part 410 and a vertical driving part 420. The horizontal driving part 410 is connected to the horizontal lines PL to drive the horizontal lines PL, and the vertical driving part 420 is connected to the vertical lines VL to drive the vertical lines VL. In an exemplary embodiment, the horizontal driving part 410 may be a gate driving part, and the vertical driving part 420 may be a data driving part. In an exemplary embodiment, the horizontal driving part 410 and the vertical driving part 420 may be disposed, e.g., mounted, on the touch display panel 300 in the form of chip-on-film. In an alternative exemplary embodiment, the horizontal driving part 410 may be directly mounted on the touch display panel 300.

The light source part 500 receives a light source driving signal from the timing control part 120 to drive light sources. The light source driving signal may be synchronized with each of the left eye image synchronized signal LSYNC and the right eye image synchronized signal RSYNC.

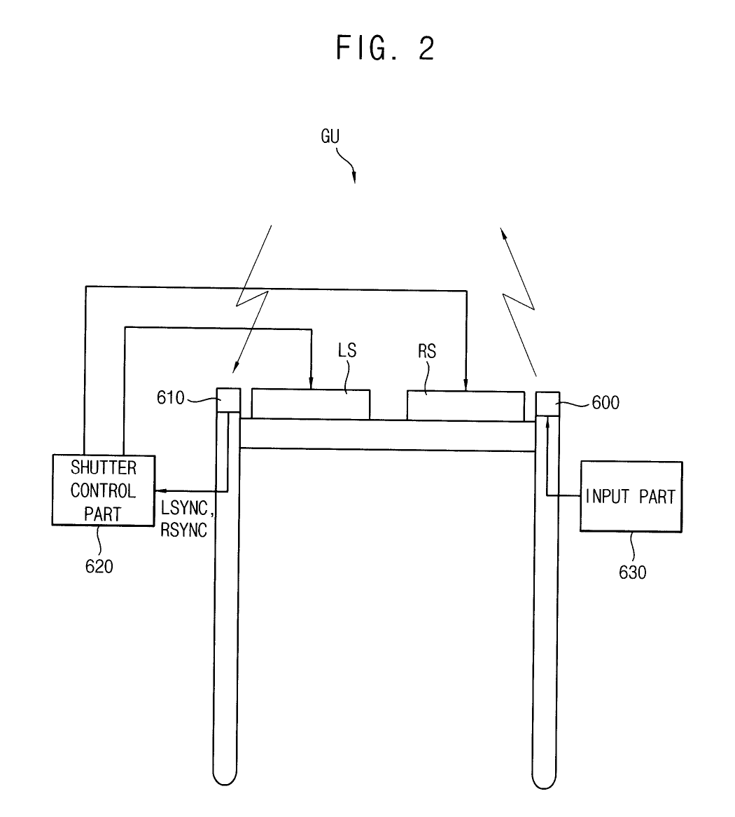

FIG. 2 is a block diagram illustrating an exemplary embodiment of the shutter glass unit of FIG. 1.

Referring to FIGS. 1 and 2, the shutter glasses part GU includes a left eye LC shutter LS, a right eye LC shutter RS, a second light-emitting part 600, a second light-receiving part 610, a shutter control part 620 and an input part 630.

Each of the left eye LC shutter LS and the right eye LC shutter RS may be a liquid crystal shutter. The left eye LC shutter LS is open and the right eye LC shutter RS is closed during a frame, in which the left eye image is displayed on the touch display panel 300. The right eye LC shutter RS is open and the left eye LC shutter LS is closed during a frame, in which the right eye image is displayed on the touch display panel 300.

The second light-emitting part 600 receives the remote control signal 3D_RC from the input part 630 to provide the remote control signal 3D_RC to the first light-receiving part 210 of the touch display panel 300. The second light-receiving part 610 receives the left eye image synchronized signal LSYNC and the right eye image synchronization RSYNC from the first light-emitting part 200 of the touch display panel 300 to provide the left eye image synchronized signal LSYNC and the right eye image synchronization RSYNC to the shutter control part 620. In an exemplary embodiment, the second light-emitting part 600 may be an IR light-emitting diode. In an alternative exemplary embodiment, the second light-emitting part 600 may be a radio frequency generator.

The shutter control part 620 opens and closes each of the left eye LC shutter LS and the right eye LC shutter RS based on the left eye image synchronized signal LSYNC and the right eye image synchronized signal RSYNC.

The input part 630 includes an input device including a button or a switch, for example, to input a user's command The user's command may be inputted to the input part 630, to turn on or turn off the 3D stereoscopic image, to control a distance of a 3D stereoscopic image from the touch display panel 300, or to control the intensity of the IR outputted from the first light-emitting part 200. In one exemplary embodiment, for example, the input part 630 may generate the 3D stereoscopic image on-controlling signal to display the 3D stereoscopic image on the touch display panel 300 displaying the two-dimensional (“2D”) image based on the user's command. The 3D stereoscopic image on-controlling signal is provided to the timing control part 120 through the second light-emitting part 600 and the first light-receiving part 210 to display the 3D stereoscopic image on the touch display panel 300.

The input part 630 may generate the 3D stereoscopic image off-controlling signal displaying the 2D image on the touch display panel 300 displaying the 3D stereoscopic image based on the user's command. The 3D stereoscopic image off-controlling signal is provided to the timing control part 120 through the second light-emitting part 600 and the first light-receiving part 210 to display the 2D image on the touch display panel 300.

In an exemplary embodiment, the input part 630 may generate a 3D stereoscopic image distance-controlling signal to control a distance of the 3D stereoscopic image displayed on the touch display panel 300 from a surface of the touch display panel 300 based on the user's command. The 3D stereoscopic image distance-controlling signal is provided to the timing control part 120 through the second light-emitting part 600 and a first light-receiving part 210 to control the distance of the 3D stereoscopic image from the surface of the touch display panel 300. In one exemplary embodiment, for example, the 3D stereoscopic image distance-controlling signal may be used to control the distance between the 3D stereoscopic image and the user. In an exemplary embodiment, the 3D stereoscopic image distance-controlling signal corresponding to predetermined levels may be generated, such that the distance between the 3D stereoscopic image and the user may be controlled to be in the predetermined levels based on the user's command.

In an exemplary embodiment, the input part 630 may generate an IR output intensity-controlling signal to control the IR output intensity of the first light-emitting part 200 by the user. The IR output intensity-controlling signal is provided to the timing control part 120 through the second light-emitting part 600 and a first light-receiving part 210 to control the IR output intensity of the first light-emitting part 200. Thus, the user may watch the 3D stereoscopic image regardless of distance between the LC shutter glass unit GU and the touch display panel 300.

In one exemplary embodiment, for example, when the LC shutter glass unit GU is spaced apart from the touch display panel 300 by a first distance, the timing control part 120 may generate a first IR output intensity-controlling signal to control the first light-emitting part 200 to emit IR of a first output intensity. When the LC shutter glass unit GU is spaced apart from the touch display panel 300 by a second distance greater than the first distance, the timing control part 120 may generate a second IR output intensity-controlling signal to control the first light-emitting part 200 to output IR of a second output intensity greater than the first output intensity.

The input part 630 may control the output intensity of IR emitted from the first light-emitting part 200 to be in predetermined levels based on the user's command

Hereinafter, an exemplary embodiment of a method of driving the display system DS will now be described.

Referring to FIGS. 1 and 2, an exemplary embodiment of a method of driving the first light-emitting part 200 of the touch display panel 300 and the second light-receiving part 610 of the shutter glasses part GU will be explained. The 3D compressed image LR for displaying the 3D stereoscopic image on the touch display panel 300 is divided into the first left eye image L1 and the first right eye image R1 by the 3D stereoscopic image processing part 100. Then, the first left eye image L1 and the first right eye image R1 are scaled-up to have the resolution corresponding to the resolution of the touch display panel 300 by the scaler 110. Thus, the first left eye image L1 and the first right eye image R1 are converted to the second left eye image L2 and the second right eye image R2, respectively.

Then, the second left eye image L2 and the second right eye image R2 are provided to the timing control part 120, and the timing control part 120 directly generates the left eye image synchronized signal LSYNC synchronized with the second left eye image L2 and the right eye image synchronized signal RSYNC synchronized with the second right eye image R2 to provide the left eye image synchronized signal LSYNC and the right eye image synchronized signal RSYNC to the first light-emitting part 200.

Then, the first light-emitting part 200 outputs the left eye image synchronized signal LSYNC and the right eye image synchronized signal RSYNC to the LC shutter glass unit GU.

The LC shutter glass unit GU opens or closes the left eye LC shutter LS and the right eye LC shutter of the LC shutter glass unit GU based on the left eye image synchronized signal LSYNC and the right eye image synchronized signal RSYNC received from the first light-emitting part 200.

Hereinafter, an exemplary embodiment of a method of driving the first light-receiving part 210 of the touch display panel 300 and the second light-emitting part 600 of the LC shutter glass unit GU will be explained. When the user's command is inputted to the input part 630 of the LC shutter glass unit GU through the input device, the input part 630 generates the remote control signal 3D_RC to provide the remote control signal 3D_RC to the second light-emitting part 600.

Then, the second light-emitting part 600 outputs the remote control signal 3D_RC including information on the user's command toward the touch display panel 300.

The first light-receiving part 210 of the touch display panel 300 detects the remote control signal 3D_RC, converts the remote control signal 3D_RC to a current, and provides the current to the timing control part 120. The timing control part 120 generates a signal using an integrated chip (“IC”) pre-programmed based on the information on the user's command in the remote control signal 3D_RC to provide the signal to the external device (for example, a central process unit or a graphic processing unit).

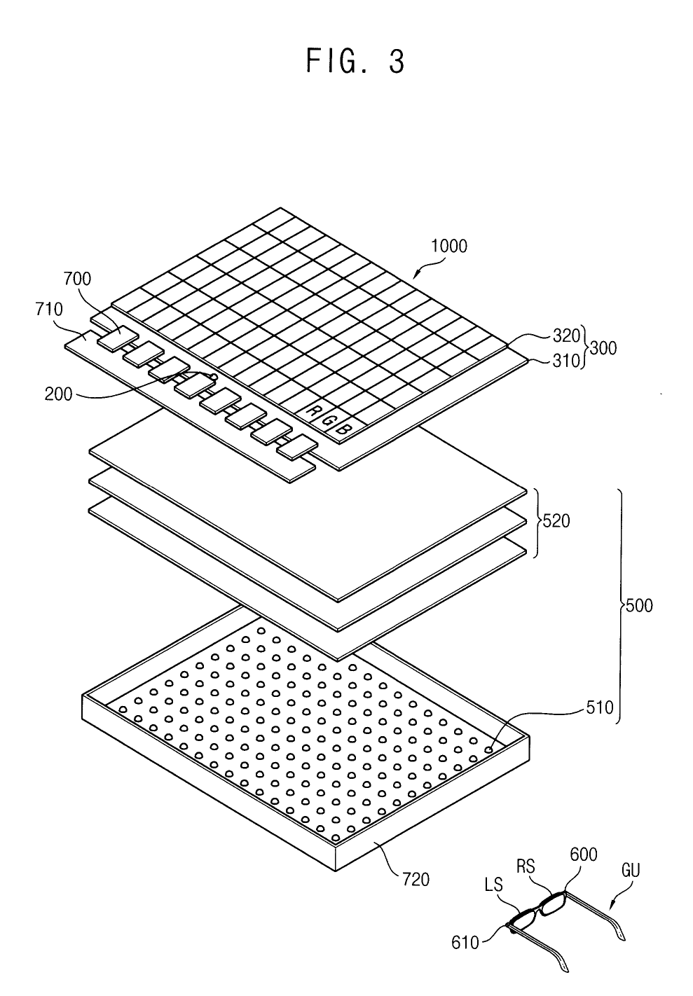

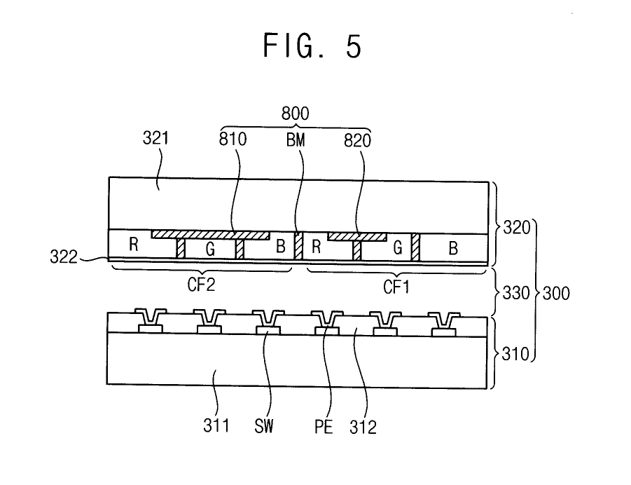

FIG. 3 is an exploded perspective view of an exemplary embodiment of the display apparatus of FIG. 1. FIG. 4 is a partial block diagram illustrating an exemplary embodiment of the touch display panel of FIG. 3. FIG. 5 is a partial cross-sectional view of the touch display panel of FIG. 3.

Referring to FIGS. 3 to 5, the display apparatus 1000 includes a touch display panel 300, a driving film 700, a printed circuit board (“PCB”) 710, a first light-emitting part 200, a light source part 500, a container 720 and a LC shutter glass unit GU.

The touch display panel 300 includes an array substrate 310, an opposite substrate 320 disposed opposite to the array substrate 310, and a liquid crystal layer 330 disposed between the array substrate 310 and the opposite substrate 320.

The array substrate 310 includes a first base substrate 311, a plurality of gate lines GL, a plurality of data lines DL, a plurality of switching elements SW, a plurality of pixel electrodes PE and an insulating layer 312. The touch display panel 300 includes a display area on which the 3D stereoscopic image is displayed and a peripheral area PA around the display area DA. The switching elements SW and the pixel electrodes PE are disposed in the display area DA. A data voltage corresponding to the 3D stereoscopic image is applied to the pixel electrodes PE.

The gate lines GL extends in a first direction D1, and the data lines DL extends in a second direction D2 crossing the first direction D1. In an exemplary embodiment, the first direction D1 may be substantially perpendicular to the second direction D2. The switching elements SW are electrically connected to the gate lines GL and the data lines DL, and the pixel electrodes PE are electrically connected to the switching elements SW.

The opposite substrate 320 includes a second base substrate 321, a common electrode layer 322, a plurality of sensing lines SL, a plurality of first read-out lines LOL1, at least one second read-out line LOL2, a plurality of sensing parts 800, a blocking layer BM, a plurality of first color filters CF1 and a plurality of second color filters CF2. The second base substrate 321 is disposed opposite to the first base substrate 311. In an exemplary embodiment, at least one sensing part of the sensing parts 800 functions as the first light-receiving part that receives the remote control signal 3D_RC from the LC shutter glass unit GU (e.g., the reference numeral 210 of FIG. 1), such that the opposite substrate 320 includes the first light-receiving part 210. The sensing lines SL, the first read-out lines LOL1, the second read-out line LOL2 and the sensing parts 800 may be disposed in the display area DA.

As shown in FIG. 1, the sensing lines SL are driven by the horizontal driving part 410, and the data lines DL, the first read-out lines LOL1 and the second read-out line LOL2 area driven by the vertical driving part 420. The horizontal driving part 410 may be a gate driving part, and the vertical driving part 420 may be a data driving part.

The sensing parts 800 include a plurality of first sensing elements 810 that senses IR and a plurality of second sensing elements 820 that senses visible light. In an exemplary embodiment, the first sensing elements 810 may be IR receiving diodes, and the second sensing elements 820 may be visible light receiving diodes. The first and second sensing elements 810, 820 may be disposed alternately in one of the first direction D1 and the second direction D2.

The sensing lines SL extend in the first direction D1 and are disposed substantially parallel to the gate lines GL. The first read-out lines LOL1 extend in the second direction D2 and are disposed substantially parallel to the data lines DL. The second read-out line LOL2 is disposed substantially parallel to the first read-out lines LOL1.

Each of the sensing parts 800 correspond to at least one pixel electrode of the plurality of pixel electrodes PE. In one exemplary embodiment, for example, each of the sensing parts 800 corresponds to three pixel electrodes PE of the plurality of pixel electrodes PE. Each of the sensing parts 800 is electrically connected to the sensing lines SL and the first read-out lines LOL1 and is driven by the sensing lines SL, such that the sensing parts 800 detects a position signal including touch position information using the first read-out lines LOL1. The first sensing elements 810 of the sensing part 800 may sense the IR provided from the light source part 500, and the second sensing element 820 of the sensing part 800 may sense the visible light provided from the light source part 500.

In an exemplary embodiment, at least one of the first sensing elements 810, which senses IR, functions as the first light-receiving part 210 to sense the IR provided from the LC shutter glass unit GU. In one exemplary embodiment, for example, the at least one of the first sensing elements 810 is connected to both the second read-out line LOL2 and the first read-out lines LOL1 to sense the IR provided from the LC shutter glass unit GU through the second read-out line LOL2. The IR provided from the LC shutter glass unit GU corresponds to the remote control signal 3D_RC, which includes the information on the user's command

The first color filters CF1 include a red color filter R, a green color filter G and a blue color filter B. The first color filters CF1 display the light provided from the light source part 500 with red, green and blue light.

The second color filters CF2 correspond to the first sensing element 810 that functions as the first light-receiving part 210, which receives the remote control signal 3D_RC from the LC shutter glass unit GU. In an exemplary embodiment, the second color filter CF2 may be disposed overlapping the first sensing element 810 that functions as the first light-receiving part 210. In an exemplary embodiment, the second color filters CF2 may have characteristics based on spectroscopic characteristics of the IR provided from the second light-emitting part 600 of the LC shutter glass unit GU. In an alternative exemplary embodiment, although not shown in the figure, the second color filters CF2 may be omitted, and a transparent organic layer may be included overlapping the first sensing element 810 that functions as the first light-receiving part 210.

The driving film 700 includes the vertical driving part 420. The driving film 700 is disposed between the touch display panel 300 and the PCB 710, and connects the touch display panel 300 and the PCB 710 to provide a signal (for example, a position signal and a remote control signal) provided from the first and second read-out lines LOL1 and LOL2 of the touch display panel 300 to the timing control part 120 of the PCB 710.

The PCB 710 includes the timing control part 120. In an exemplary embodiment, the first light-emitting part 200 may be an IR emitting diode. In an alternative exemplary embodiment, the first light-emitting part 200 may be a radio frequency generator. The first light-emitting part 200 is connected to the timing control part 120 of the PCB 710 to transmit the left eye image synchronized signal LSYNC and the right eye image synchronized signal RSYNC to the LC shutter glass unit GU.

The first light-emitting part 200 may be connected to the PCB 710 by a wire WL. The first light-emitting part 200 may be attached in the peripheral area PA of the touch display panel 300 by an adhesive.

The light source part 500 is disposed below the touch display panel 300. The light source part 500 includes a plurality of light sources 510. The light source part 500 may further include a light control member 520 that controls the light sources 510, e.g., controls brightness of the light sources 510. In an exemplary embodiment, the light sources 510 may include IR emitting diodes and visible light-emitting diodes. The light control member 520 may include a light diffusion sheet and a light controlling sheet, for example. The container 720 may receive the light source part 500.

In an exemplary embodiment, the display apparatus 1000 uses at least one of the first sensing elements 810 disposed in the display area DA of the touch display panel 300 as the first light-receiving part 210, such that manufacturing cost is substantially reduced.

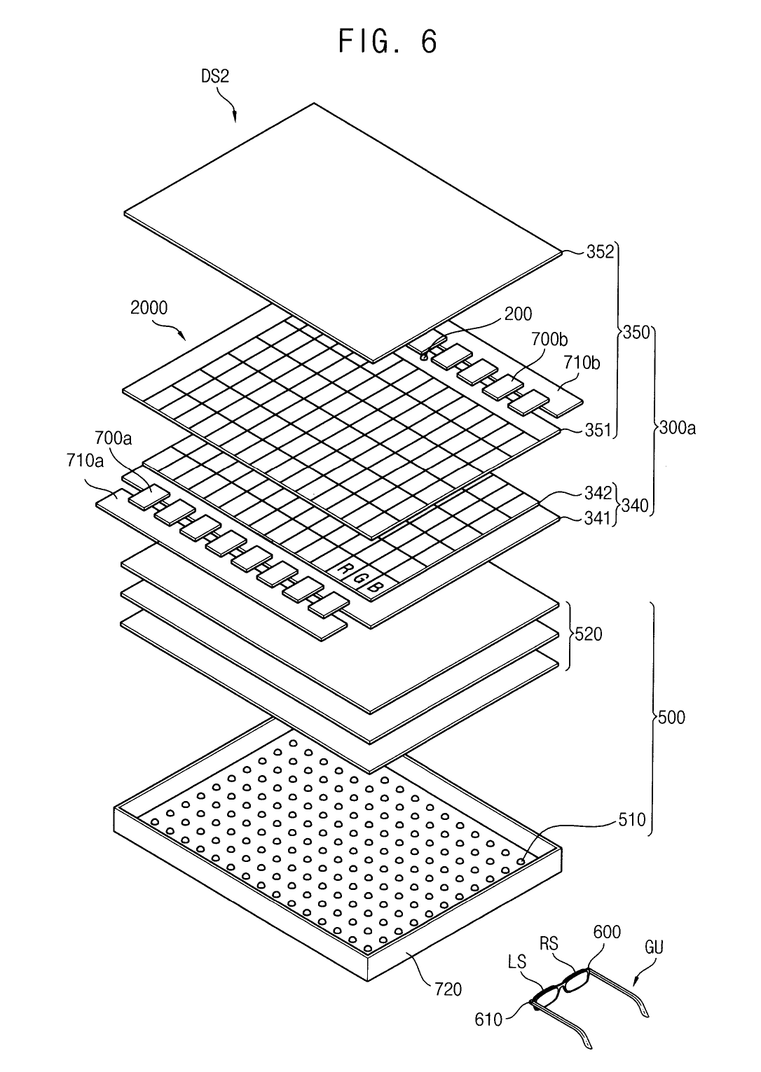

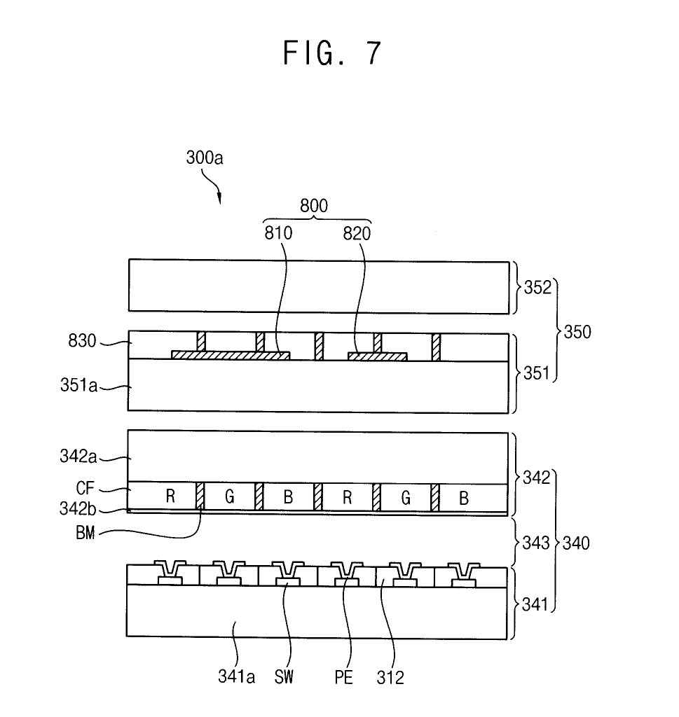

FIG. 6 is an exploded perspective view of an alternative exemplary embodiment of the display system according to the present invention. FIG. 7 is a partial cross-sectional view of an exemplary embodiment of the touch display panel of FIG. 6.

The display system in FIG. 6 is substantially the same as the display system illustrated in FIG. 1 except for a first light-receiving part disposed in the display area of the touch panel. The same or like elements shown in FIGS. 6 and 7 have been labeled with the same reference characters as used above to describe the exemplary embodiments of the display system shown in FIGS. 3 to 5, and any repetitive detailed description thereof will hereinafter be omitted or simplified.

Referring to FIGS. 6 and 7, the display system DS2 includes a display apparatus 2000 and an LC shutter glass unit GU. The display apparatus 2000 includes a touch display panel 300a, a first driving film 700a, a second driving film 700b, a first PCB 710a, a second PCB 710b, a first light-emitting part 200, a light source part 500 and a container 720.

The touch display panel 300a includes a display panel 340 and a touch panel 350 disposed on the display panel 340. The touch display panel 300a includes a display area DA, on which a 3D stereoscopic image is displayed, and a peripheral area PA around the display area DA.

The display panel 340 includes an array substrate 341, an opposite substrate 342 disposed opposite to the array substrate 341, and a liquid crystal layer 343 disposed between the array substrate 341 and the opposite substrate 342. The array substrate 341 includes a first base substrate 341a, a plurality of gate lines GL, a plurality of data lines DL, a plurality of switching elements SW and a plurality of pixel electrodes PE. The gate lines GL, the data lines DL, the switching elements SW and the pixel electrodes PE are disposed in the display area DA. A data voltage corresponding to the 3D stereoscopic image is applied to the pixel electrodes PE.

The opposite substrate 342 may include a second base substrate 342a, a plurality of color filters CF, a blocking layer BM and a common electrode layer 342b. The second base substrate 342a is disposed opposite to the first base substrate 341a.

The touch panel 350 includes a sensing substrate 351 and a protecting substrate 352 opposite to the sensing substrate 351. The sensing substrate 351 includes a third base substrate 351a, a plurality sensing lines SL, a plurality of first read-out lines LOL1, at least one second read-out line LOL2, a plurality of sensing parts 800 and a protecting layer 830. At least one of the sensing parts 800 functions as the first light-receiving part (e.g., the reference numeral 210 of FIG. 1). In one exemplary embodiment, the at least one of the sensing parts 800 receives the remote control signal 3D_RC from the LC shutter glass unit GU. The sensing lines SL, the first read-out lines LOL1, the at least one second read-out line LOL2 and the sensing parts 800 are disposed in the display area DA.

The sensing parts 800 include a plurality of first sensing elements 810 that senses IR and a plurality of second sensing elements 820 that senses visible light. The first sensing elements 810 may be an IR receiving diode, and the second sensing elements 820 may be a visible light receiving diode. The first and second sensing elements 810 and 820 may be disposed alternately in at least one of a first direction D1 and a second direction D2 crossing the first direction D1.

The sensing lines SL extends in the first direction D1 and are disposed substantially parallel to the gate lines GL. The first read-out lines LOL1 extends in the second direction D2 and are disposed substantially parallel to the data lines DL. The at least one second read-out line LOL2 is disposed substantially parallel to the first read-out lines LOL1.

Each of the sensing parts 800 correspond to at least one pixel electrode of the plurality of pixel electrodes PE. In one exemplary embodiment, for example, each of the sensing parts 800 corresponds to three pixel electrodes of the plurality of pixel electrodes PE. Each of the sensing parts 800 is electrically connected to the sensing lines SL and the first read-out lines LOL1 and is driven by the sensing lines SL, such that the sensing parts 800 detect a position signal including touch position information using the first read-out lines LOL1. The first sensing elements 810 of the sensing parts 800 may sense the IR provided from the light source part 500, and the second sensing elements 820 of the sensing parts 800 may sense the visible light provided from the light source part 500.

At least one of the first sensing elements 810 that sense IR functions as the first light-receiving part 210 to sense the IR provided from the LC shutter glass unit GU. In one exemplary embodiment, for example, at least one of the first sensing elements 810 is connected to both the second read-out line LOL2 and the first read-out lines LOL1 to sense the IR provided from the LC shutter glass unit GU through the second read-out line LOL2. The IR provided from the LC shutter glass unit GU corresponds to the remote control signal 3D RC, which includes the user's command

Referring back to FIG. 1, the vertical driving part 420 includes a data driving part and a read-out driving part, and the horizontal driving part 410 includes a gate driving part and a sensing driving part.

Referring now to FIG. 6, the first driving film 700a includes the data driving part of the vertical driving part 420. The first driving film 700a is disposed between the display panel 340 and the first PCB 710a, and the first driving film 700a is electrically connected to each of the display panel 340 and the first PCB 710a to provide the data voltage to the data lines DL of the display panel 340.

The second driving film 700b includes the read-out driving part of the vertical driving part 420. The second driving film 700b is disposed between the touch panel 350 and the second PCB 710b, and the second driving film 700b is electrically connected to the touch panel 350 and the second PCB 710b to provide a signal (for example, a position signal and a remote control signal) received from the first and second read-out lines LOL1 and LOL2 to the timing control part 120.

Each of the first PCB 710a and the second PCB 710b includes the timing control part 120. The first light-emitting part 200 may be an IR emitting diode. The first light-emitting part 200 is connected to the timing control part 120 of the first and second PCBs 710a and 720b to transmit the left eye image synchronized signal LSYNC and the right eye image synchronized signal RSYNC to the LC shutter glass unit GU.

The first light-emitting part 200 may be connected to the first and second PCBs 710a and 710b through a wire WL. The first light-emitting part 200 may be attached in the peripheral area PA of the touch panel 350 by an adhesive.

According to the exemplary embodiment in FIG. 6, the display system DS2 includes at least one of the first sensing elements 810 that is disposed in the display area DA of the touch panel 350 and functions as the first light-receiving part 210 that receives the remote control signal 3D_RC from the LC shutter glass unit GU, such that the manufacturing cost is substantially reduced.

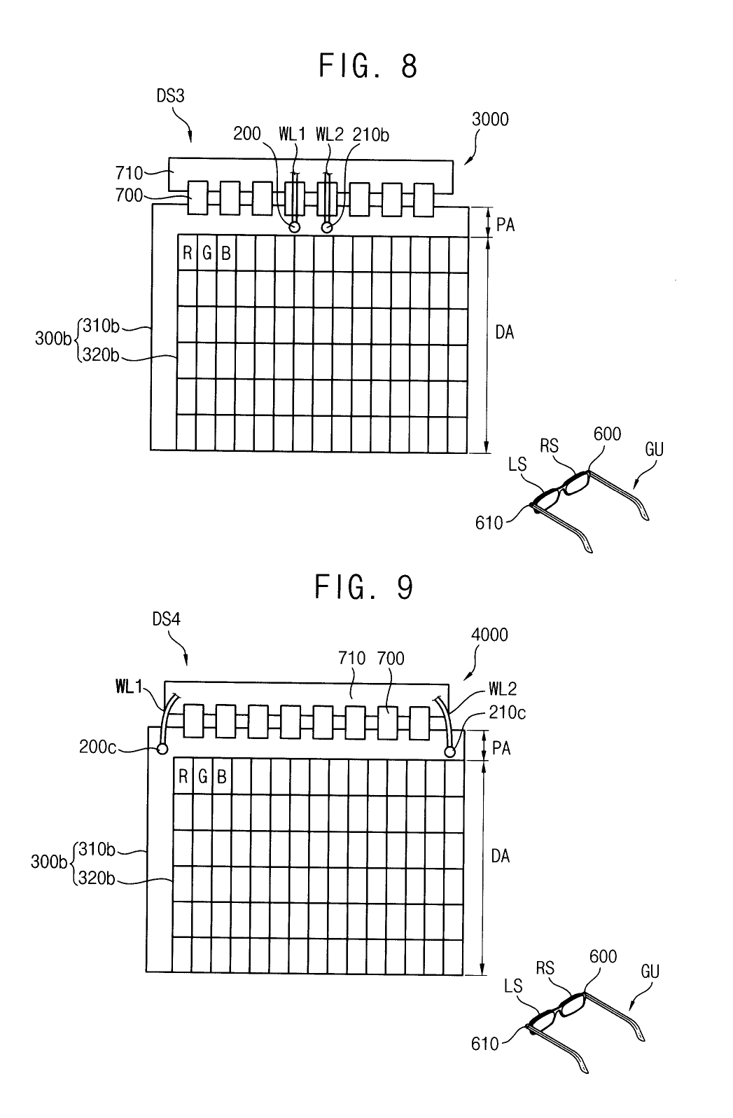

FIG. 8 is a top plan view of an alternative exemplary embodiment of the display system according to the present invention.

The display system in FIG. 8 is substantially the same as the display system shown in FIGS. 3 to 5 except for a first light-receiving part disposed in the peripheral area of the display panel. The same or like elements shown in FIG. 8 have been labeled with the same reference characters as used above to describe the exemplary embodiments of the display system shown in FIGS. 3 to 5, and any repetitive detailed description thereof will hereinafter be omitted or simplified.

Referring to FIG. 8, a display system DS3 includes a display apparatus 3000 and a LC shutter glass unit GU. The display apparatus 3000 includes a display panel 300b, a first light-emitting part 200, a first light-receiving part 210b, a first wire WL1, a second wire WL2, a driving film 700 and a PCB 710. The display panel 300b includes a display area DA, in which a 3D image is displayed, and a peripheral area PA around the display area DA. The display panel 300b includes an array substrate 310b, an opposite substrate 320b disposed opposite to the array substrate 310b and a liquid crystal layer (not shown) disposed between the array substrate 310b and the opposite substrate 320b.

The first light-emitting part 200 is disposed in the peripheral area PA of the display panel 300b. In one exemplary embodiment, for example, the first light-emitting part 200 is disposed in the peripheral area between the driving film 700 and the PCB 710. The first light-emitting part 200 is connected to the PCB 710 through the first wire WL 1 and receives a left eye image synchronized signal LSYNC and a right eye image synchronized signal RSYNC generated from a timing control part 120 included in the PCB 710. Thus, the first light-emitting part 200 transmits the left eye image synchronized signal LSYNC and the right eye image synchronized signal RSYNC to a second light-receiving part 610 of the LC shutter glass unit GU. The first wire WL1 may be disposed on the driving film 700. In one exemplary embodiment, for example, the first wire WL1 may be bonded on the driving film 700. In an alternative exemplary embodiment, the first wire WL1 may be patterned on one of the display panel 300b, the driving film 700 and the PCB 710.

The first light-receiving part 210b is disposed in the peripheral area PA near the driving film 700 and the PCB 710. The first light-receiving part 210b is connected to the PCT 710 through the second wire WL2 and provides a remote control signal 3D_RC received from a second light-emitting part 600 of the LC shutter glass unit GU to a timing control part 120 included in the PCB 710. The second wire WL2 may be disposed on the driving film 700. In one exemplary embodiment, for example, the second wire WL2 may be bonded on the driving film 700. In an alternative exemplary embodiment, the second wire WL2 may be patterned on one of the display panel 300b, the driving film 700 and the PCB 710.

Therefore, the first light-emitting part 200 may transmit the left eye image synchronized signal LSYNC and the right eye image synchronized signal RSYNC generated in the timing control part 120 to the LC shutter glass unit GU, and the first light-receiving part 210b may receive the remote control signal 3D_RC from the LC shutter glass unit GU.

According to the exemplary embodiment in FIG. 8, the display apparatus 3000 of the display system DS3 includes the first light-emitting part 200 and the first light-receiving part 210b connected to the timing control part 120, such that the user may use the display system without a self-installation process for the first light-emitting part 200 and the first light-receiving part 210b.

FIG. 9 is a top plan view of another alternative exemplary embodiment of the display system according to the present invention.

The display system in FIG. 9 is substantially the same as the display system shown in FIGS. 3 to 5 except for a first light-receiving part disposed in the peripheral area of the display panel. The same or like elements shown in FIG. 9 have been labeled with the same reference characters as used above to describe the exemplary embodiments of the display system shown in FIGS. 3 to 5, and any repetitive detailed description thereof will hereinafter be omitted or simplified.

Referring to FIG. 9, the display system DS4 includes a display apparatus 4000 and an LC shutter glass unit GU. The display apparatus 4000 includes a display panel 300b, a first light-emitting part 200c, a first light-receiving part 210c, a first wire WL1, a second wire WL2, a driving film 700 and a PCB 710. The display panel 300b includes a display area DA, in which a 3D image is displayed, and a peripheral area PA around the display area DA. The display panel 300b includes an array substrate 310b, an opposite substrate 320b disposed opposite to the array substrate 310b and a liquid crystal layer (not shown) disposed between the array substrate 310b and the opposite substrate 320b.

The first light-emitting part 200c is disposed in the peripheral area PA of the display panel 300b. In one exemplary embodiment, for example, the first light-emitting part 200c is disposed at an edge of the peripheral area PA of the display panel 300b. The first light-emitting part 200c is connected to the PCB 710 through the first wire WL1 and receives a left eye image synchronized signal LSYNC and a right eye image synchronized signal RSYNC generated from the timing control part 120 included in the PCB 710. Thus, the first light-emitting part 200c transmits the left eye image synchronized signal LSYNC and the right eye image synchronized signal RSYNC to a second light-receiving part 610 of the LC shutter glass unit GU.

The first light-receiving part 210c is disposed in the peripheral area PA near the driving film 700 and the PCB 710. The first light-receiving part 210c is connected to the PCB 710 through the second wire WL2 and provides a remote control signal 3D_RC received from a second light-emitting part 600 of the LC shutter glass unit GU to the timing control part 120 included in the PCB 710.

Therefore, the first light-emitting part 200c may transmit the left eye image synchronized signal LSYNC and the right eye image synchronized signal RSYNC generated from the timing control part 120 to the LC shutter glass unit GU, and the first light-receiving part 210c may receive the remote control signal 3D_RC from the LC shutter glass unit GU.

According to the exemplary embodiment in FIG. 9, the display apparatus 4000 of the display system DS4 includes the first light-emitting part 200c and the first light-receiving part 210c connected to the timing control part 120, such that the user may use the display system without a self-installation process for the first light-emitting part 200c and the first light-receiving part 210c.

According to exemplary embodiments of the present invention as described herein, at least one of sensing elements disposed in a display area of a touch display panel functions as a first light-receiving part that receives a remote control signal transmitted from a shutter glasses part, such that a structure of the display system is substantially simplified, and manufacturing cost of the display system is substantially reduced.

According to exemplary embodiments of the present invention as described herein, a first light-emitting part, which transmits a left eye image synchronized signal and a right eye image synchronized signal that open or close a left eye LC shutter and a right eye LC shutter of a LC shutter glass unit, respectively, is disposed in a peripheral area of the touch display panel, such that a user may use the display system without a self-installation process for the first light-emitting part.

In exemplary embodiments, a first light-receiving part that receives a remote control signal transmitted from a LC shutter glass unit is formed disposed in a peripheral area of the display panel, such that a user may use the display system without a self-installation process for the first light-receiving part.

The foregoing is illustrative of the present invention and is not to be construed as limiting thereof Although a few exemplary embodiments of the present invention have been described, those skilled in the art will readily appreciate that many modifications are possible in the exemplary embodiments without materially departing from the novel teachings and advantages of the present invention. Accordingly, all such modifications are intended to be included within the scope of the present invention as defined in the claims. In the claims, means-plus-function clauses are intended to cover the structures described herein as performing the recited function and not only structural equivalents but also equivalent structures. Therefore, it is to be understood that the foregoing is illustrative of the present invention and is not to be construed as limited to the specific exemplary embodiments disclosed, and that modifications to the disclosed example embodiments, as well as other exemplary embodiments, are intended to be included within the scope of the appended claims. The present invention is defined by the following claims, with equivalents of the claims to be included therein.

What is claimed is:

1. A display apparatus comprising:
a touch display panel which displays a three-dimensional stereoscopic image and senses a touch position; and
a light-receiving part disposed on the touch display panel, wherein the light-receiving part receives a remote control signal generated from shutter glasses used to view the three-dimensional stereoscopic image from the touch display panel.

2. The display apparatus of claim 1, further comprising:
a timing control part which generates a left eye image synchronized signal synchronized with a left eye image of the three-dimensional stereoscopic image and a right eye image synchronized signal synchronized with a right eye image of the three-dimensional stereoscopic image; and
a light-emitting part disposed on the touch panel, wherein the light-emitting part transmits the left eye image synchronized signal and the right eye image synchronized signal to the shutter glasses.

3. The display apparatus of claim 1, wherein the touch display panel comprises:
an array substrate comprising:
a first base substrate; and
a plurality of pixel electrodes disposed in a display area of the first base substrate, wherein a data voltage corresponding to the three-dimensional stereoscopic image is applied to the plurality of pixel electrodes; and
an opposite substrate comprising:
a second base substrate disposed opposite to the first base substrate; and
a plurality of sensing elements disposed in a display area of the second base substrate,
wherein the light-receiving part is disposed in the display area of the second base substrate.

4. The display apparatus of claim 3, wherein the opposite substrate further comprises a read-out line connected to the light-receiving part, and
wherein the remote control signal from the light-receiving part is transmitted through the read-out line.

5. The display apparatus of claim 2, wherein the timing control part controls the three-dimensional stereoscopic image displayed on the touch display panel based on the remote control signal received through the light-receiving part.

6. The display apparatus of claim 1, wherein the touch display panel comprises:
a display panel comprising a plurality of pixel electrodes disposed in a display area thereof, wherein the plurality of pixel electrodes receives a data voltage corresponding to the three-dimensional stereoscopic image; and
a touch panel disposed on the display panel, wherein the touch panel comprises a plurality of sensing elements disposed in a display area thereof, and the plurality of sensing elements senses infrared light,
wherein the light-receiving part is disposed in the display area of the touch panel.

7. The display apparatus of claim 6, wherein the touch panel further comprises a read-out line connected to the light-receiving part, and
wherein the remote control signal is transmitted through the read-out line.

8. The display apparatus of claim 6, further comprising a timing control part which controls the three-dimensional stereoscopic image displayed on the touch display panel based on the remote control signal received through the light-receiving part.

9. A display apparatus comprising:
a display panel comprising a display area, in which a three-dimensional stereoscopic image is displayed, and a peripheral area around the display area; and
a light-receiving part disposed in the peripheral area of the display panel,
wherein a plurality of pixels is disposed in the display area of the display panel, and
wherein the light-receiving part receives a remote control signal generated from shutter glasses used to view the three-dimensional stereoscopic image from the display panel.

10. The display apparatus of claim 9, further comprising:
a timing control part which generates a left eye image synchronized signal and a right eye image synchronized signal, wherein the left eye image synchronized signal and the right eye image synchronized signal are synchronized with a left eye image of the three-dimensional stereoscopic image and a right eye image of the three-dimensional stereoscopic image, respectively; and
a light-emitting part disposed in the display area, wherein the light-emitting part transmits the left eye image synchronized signal and the right eye image synchronized signal to the shutter glasses.

11. A display system comprising:
a touch display panel which displays a three-dimensional stereoscopic image and senses a touch position;
a liquid crystal shutter glass unit comprising:
a left eye liquid crystal shutter;
a right eye liquid crystal shutter; and
a first light-emitting part which transmits a remote control signal; and
a first light-receiving part disposed on the touch display panel, wherein the first light-receiving part receives the remote control signal.

12. The display system of claim 11, further comprising:
a timing control part which generates a left eye image synchronized signal synchronized with a left eye image of the three-dimensional stereoscopic image and a right eye image synchronized signal synchronized with a right eye image of the three-dimensional stereoscopic image; and
a second light-emitting part disposed on the touch display panel, wherein the second light-emitting part transmits the left eye image synchronized signal and the right eye image synchronized signal to the liquid crystal shutter glass unit.

13. The display system of claim 12, wherein the liquid crystal shutter glass unit further comprises:
a second light-receiving part which receives the left eye image synchronized signal and the right eye image synchronized signal; and
a shutter control part which opens or closes the left eye liquid crystal shutter and the right eye liquid crystal shutter based on the left eye image synchronized signal and the right eye image synchronized signal.

14. The display system of claim 11, wherein the liquid crystal shutter glass unit further comprise:
an input part which receives a user's command; and
a signal generating part which generates the remote control signal based on the user's command

15. The display system of claim 11, wherein the touch display panel comprises:
an array substrate comprising:
a first base substrate; and
a plurality of pixel electrodes disposed in a display area of the first base substrate, wherein a data voltage corresponding to the three-dimensional stereoscopic image is applied to the plurality of pixel electrodes; and
an opposite substrate comprising:
a second base substrate disposed opposite to the first base substrate; and
a plurality of sensing elements disposed in a display area of the second base substrate, wherein the plurality of sensing elements senses infrared light,
wherein the first light-receiving part is disposed in the display area of the second base substrate.

16. The display system of claim 11, wherein the touch display panel comprises:
a display panel comprising a plurality of pixel electrodes disposed in a display area thereof, wherein the plurality of pixel electrodes receives a data voltage corresponding to the three-dimensional stereoscopic image; and
a touch panel disposed on the display panel, wherein the touch panel comprises a plurality of sensing elements disposed in a display area thereof, and the plurality of sensing elements senses infrared light,
wherein the first light-emitting part is disposed in the display area of the touch panel.

17. A display system comprising:
a display panel including a display area, in which a three-dimensional image is displayed, and a peripheral area around the display area, wherein a plurality of pixels is disposed in the display area;
an liquid crystal shutter glass unit comprising:
a left eye liquid crystal shutter;
a right eye liquid crystal shutter; and
a first light-emitting part which transmits a remote control signal; and
a first light-receiving part disposed in the peripheral area, wherein the first light-receiving part receives the remote control signal.

18. The display system of claim 17, further comprising:
a timing control part which generates a left eye image synchronized signal synchronized with a left eye image of the three-dimensional stereoscopic image and a right eye image synchronized signal synchronized with a right eye image of the three-dimensional stereoscopic image; and
a second light-emitting part disposed in the peripheral area, wherein the second light-emitting part transmits the left eye image synchronized signal and the right eye image synchronized signal to the liquid crystal shutter glass unit.

19. The display system of claim 18, wherein the liquid crystal shutter glass unit further comprises:
a second light-receiving part which receives the left eye image synchronized signal and the right eye image synchronized signal; and
a shutter control part which opens or closes the left eye liquid crystal shutter and the right eye liquid crystal shutter based on the left eye image synchronized signal and the right eye image synchronized signal.

20. The display system of claim 17, wherein the liquid crystal shutter glass unit further comprises:
an input part which receives a user's command; and
a signal generating part which generates the remote control signal based on the user's command.
